(19) United States
(12) Patent Application Publication
(10) Pub. No.: US 2005/0091504 A1
(43) Pub. Date: Apr. 28, 2005

(54) Storage apparatus and access management method therefor

(75) Inventor: Tetsuya Shirogane, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/765,289

(22) Filed: Jan. 26, 2004

(30) Foreign Application Priority Data
Oct. 28, 2003 (JP) 2003-367152

(51) Int. Cl. H04K 1/00

(52) U.S. Cl. 713/182

(57) ABSTRACT

An access control management method is provided for managing access permits for access requests transmitted by an external apparatus to a storage apparatus by way of a network. The storage apparatus receives a frame of a login request from the external apparatus and determines whether or not the received frame includes second information for identifying the external apparatus (first determination process). In a case where a result of the first determination process indicates that the frame does not include the second information, acquisition of first information for identifying the external apparatus from the external apparatus is requested and the acquired first information is checked in order to determine whether or not an access permit should be given to the external apparatus (second determination process). In a case where a result of the second determination process indicates that an access permit should be given to the external apparatus, an access request made by the external apparatus as a request for an access to the storage apparatus is approved. As a result, it is possible to improve security of an access request made by the external apparatus serving as a host computer by adoption of an iSCSI protocol as a request for an access to the storage apparatus.

### BACKGROUND OF THE INVENTION

The present invention relates to a storage apparatus and an access management method therefor. More particularly, the present invention relates to security management in a storage system allowing a host computer to make accesses to data stored in a storage apparatus in accordance with an iSCSI protocol. The host computer is also referred to hereafter simply as a host.

A storage system has been put to practical use. The storage system comprises a host and a storage apparatus, which are connected to each other by an interface. Also referred to as a storage device system, the storage apparatus comprises an aggregate including a hard-disk drive or a plurality of hard-disk drives. As an alternative, the storage apparatus comprises a disc array having a special control unit for controlling a plurality of hard-disk drives. In the storage system, the host is capable of making accesses to the storage apparatus. In general, the storage apparatus has one volume or a plurality of volumes, which are each referred to as an LU (logical unit). An ID number or a logical unit number (LUN) is assigned to each LU.

As technologies of the interface for connecting the storage apparatus to the host, an SCSI (Small Computer Systems Interface) and/or an FC (Fibre Channel) are adopted.

The SCSI interface is an inexpensive interface used for relatively short distance connections based on a client-server link. In the SCSI interface, a client plays an active role of issuing commands. The client playing an active role is thus referred to as an initiator. On he other hand a server plays a passive role of operating at a request made by a client. The server playing a passive role is thus referred to as a target. A command issued to a logical unit to make a request for a process is included in a CDB (Command Descriptor Block).

A technology for implementing security preventing an illegal access to an LU (logical unit) employed in the storage apparatus of such a storage system is disclosed in documents such as Japanese Patent Laid-open Nos. 10-333839 and 2001-265655.

In accordance with the former document, a table is stored in the storage apparatus in advance. For each LU, the table shows WWNs (World Wide Names) each assigned to a host allowed to make accesses to the LU. A WWN stored in a login frame received from a host is compared with those cataloged in the table to identify the host and to determine whether or not the host is allowed to make an access to the LU in the storage apparatus.

In accordance with the latter document, on the other hand, a relation between WWNs assigned to hosts and port IDs is stored in a table. For a frame including no WWN (e.g., a frame including CDB), the WWN for the port ID is examined to determine whether the host is allowed to make an access to the LU.

It is to be noted that, in the following description, a method of controlling whether or not a host is allowed to make an access to a specific LU in the storage apparatus is referred to as LUN security for the sake of convenience.

By the way, attention is recently paid to an iSCSI (Internet SCSI) technology, which is a protocol technology for implementing an SCSI process. The iSCSI protocol is an upper-layer protocol on the TCP/IP, which is a network protocol. As a protocol used in an IP network, the iSCSI protocol is prescribed by the IETF (the Internet Engineering Task Force).

### SUMMARY OF THE INVENTION

The IP network is cheaper than a Fibre Channel and, hence, considered to be a network with a configuration allowing an LU in a storage apparatus to be utilized by a large number of users. When data stored in an LU is damaged due to a miss-operation or an ill-will attack, however, the range of the effect of the damage is also widened. It is thus important to assure the LUN security also for an access made by using the iSCSI protocol in the IP network as an access to an LU in the storage apparatus.

In order to check the LUN security, the use of a MAC address as a host identification is conceivable. The number of bits in an MAC address is relatively small so that the size of a storage area required for management of accesses can also be made small as well. In addition, the use of an MAC address has a merit that, since an MAC address is a value peculiar to a physical network interface, an MAC address is difficult to falsify.

In the IP network, however, information may be transmitted by way of a router. In this case, the MAC address included in a datalink frame is replaced with the MAC address of the network card of the router. Thus, if a router exists between the host and the storage apparatus, there is raised a problem that the target is not capable of acquiring the MAC address of the host from a packet received from the host.

The documents disclosing the technologies of the prior art do not describe a method of acquiring the MAC address of the host in a transmission through a router in the case of an MAC address used as an identification of the host in the IP network.

It is thus an object of the present invention to provide a method of managing accesses by improving security with regard to requests made by a host to make accesses to a storage apparatus adopting the iSCSI protocol and to provide the storage apparatus for implementing the method.

It is another object of the present invention to provide a method adopted by a storage apparatus connected to an IP network to determine whether or not a login request made by a host through the IP network is permitted by identification of the host through use of an MAC address and to provide the storage apparatus for implementing the method.

It is a further object of the present invention to provide an access management method capable of changing a technique of managing accesses made to a storage apparatus connected to an IP network as accesses related to commands after a login request process in accordance with a result of determination as to whether or not a host making the requests is connected to the same IP network.

The present invention provides a storage apparatus for processing a command transmitted by a host computer connected to the storage apparatus by an IP network. The storage apparatus comprises:
a storage unit for storing data to be processed in accordance with the command;
a memory for holding an access management table for storing first information on identification of the host computer;
a first determination means for determining whether or not a frame of a login request transmitted by the host computer includes second information on identification of the host computer;
a request means for transmitting a request to a source address specified in a frame of a login request in order to request the host computer to transmit first information on identification of the host computer in a case where a determination result output by the first determination means indicates that the frame of the login request does not include desired second information; and
a second determination means for carrying out a determination process on first information transmitted by the host computer in response to the request issued by the request means by examination of the access management table, wherein a decision as to whether or not to approve the login request is made in accordance with a determination result output by the second determination means.

In a desirable implementation of the storage apparatus, an access is made to the storage apparatus by adoption of an iSCSI protocol. In addition, the first information stored in the access management table is an MAC address of an interface employed in the host computer as an interface with an IP network through which the host computer is connected to the storage apparatus.

The present invention also provides an access control management method for managing access permits for access requests transmitted by an external apparatus to a storage apparatus by way of a network. The access control management method comprises the steps of:
receiving a frame of a login request from the external apparatus in the storage apparatus;
determining whether or not the received frame includes second information for identifying the external apparatus in a first determination process;
requesting acquisition of first information for identifying the external apparatus from the external apparatus in a case where a result of the first determination process indicates that the frame does not include the second information;
checking the acquired first information in a second identification process in order to determine whether or not an access permit should be given to the external apparatus; and
approving an access request made by the external apparatus as a request for an access to the storage apparatus in a case where a result of the second determination process indicates that an access permit should be given to the external apparatus.

In a desirable implementation of the access control management method, the method further has the step of connecting the storage apparatus comprising an iSCSI layer, a TCP layer, an IP layer and a datalink layer with an IP network layer.

In the access control management method, a MAC address is used as the first information, and an IP address is used as the second information.

In addition, in another desirable implementation of the access control management method, the method further has the step of preparing a table, which is used for cataloging first information for identifying an external apparatus allowed to make accesses to the storage apparatus, in a memory in advance. In the second determination process, first information acquired from an external apparatus is checked by referencing the table in determination of whether or not an access permit should be given to the external apparatus.

In addition, at the step of requesting acquisition of first information for identifying an external apparatus from the external apparatus, an SNMP manager for monitoring an apparatus connected to an IP network requests the external apparatus to transmit the first information.

In addition, in a further desirable implementation of the access control management method, a plurality of logical units (LUs) are defined in the storage apparatus. An access management table is prepared for storing a MAC address and an identification code for identifying one of the logical units, which is accessible to an external apparatus having an IP-network interface identified by the MAC address. After the second determination process, determination is made as to whether or not an access requested by a command transmitted by an external apparatus is an access to a specific one of the logical units, which has an identification code cataloged in advance in the access management table, with regard to processing of the command in a third determination process after the second determination process. The command is processed if a result of the third determination process indicates that the access requested by the command is an access to the specific accessible logical unit.

In addition, the present invention also provides an access control management method for managing access permits for accesses made by a first apparatus as accesses to a second apparatus connected to the first apparatus by a network. Also regarded as a command-processing method, the access control management method comprises the steps of: acquiring predetermined first information from the first apparatus serving as an initiator of a communication in a case where the communication is determined to be unimplementable through the network in a first check mode of determining whether or not an access made by the first apparatus as an access to the second apparatus is an access made through the network by checking second information transmitted from the first apparatus to the second apparatus; and processing a command transmitted by the first apparatus to the second apparatus if an access requested by the command is permitted in a second check mode of determining whether or not an access made by the first apparatus as an access to the second apparatus is permitted by checking the first information acquired from the first apparatus.

In accordance with the present invention, in a storage apparatus connected to an IP network as a storage apparatus adopting an iSCSI protocol, a host is identified by using a MAC address in order to determine whether or not to approve a login request made by the host.

In addition, a method of processing a login request and a method of managing accesses can be modified in accordance with whether or not the host serving as an initiator of accesses pertains to the same network or the same segment as the storage apparatus. Thus, it is possible to enhance security of an access request made by the host as a request for an access to the storage apparatus.

### BRIEF DESCRIPTION OF THE DRAWINGS

FIG. 1 is a block diagram showing the hardware configuration of a data-processing system according to an embodiment;

FIG. 2 is a diagram showing a concept of communication between an iSCSI initiator and a target in the data-processing system according to the embodiment;

FIG. 3 is a diagram showing a typical format of a packet used in a communication between the iSCSI initiator and the target.

FIG. 4A is a diagram showing a typical configuration of a login request frame;

FIG. 4B is a diagram showing a typical configuration of a login response frame;

FIG. 5 is a diagram showing a typical configuration of an access management table 80 used in the data-processing system shown in FIG. 1;

FIG. 6 shows a flowchart representing details of an access control process carried out in the embodiment;

FIG. 7 shows a continuation flowchart representing details of the access control process carried out in the embodiment;

FIG. 8 shows a continuation flowchart representing details of the access control process carried out in the embodiment;

FIG. 9 is a diagram showing a typical configuration of an access management table according to another embodiment; and

FIG. 10A is a diagram showing sequences of access control processes to acquire a MAC address in a case where a login request is approved, according to another embodiment; and

FIG. 10B is a diagram showing sequences of access control processes to acquire a MAC address in a case where a login request ends in a failure, according to another embodiment.

### PREFERRED EMBODIMENTS OF THE INVENTION

Preferred embodiments of the present invention will below be described by referring to the drawings.

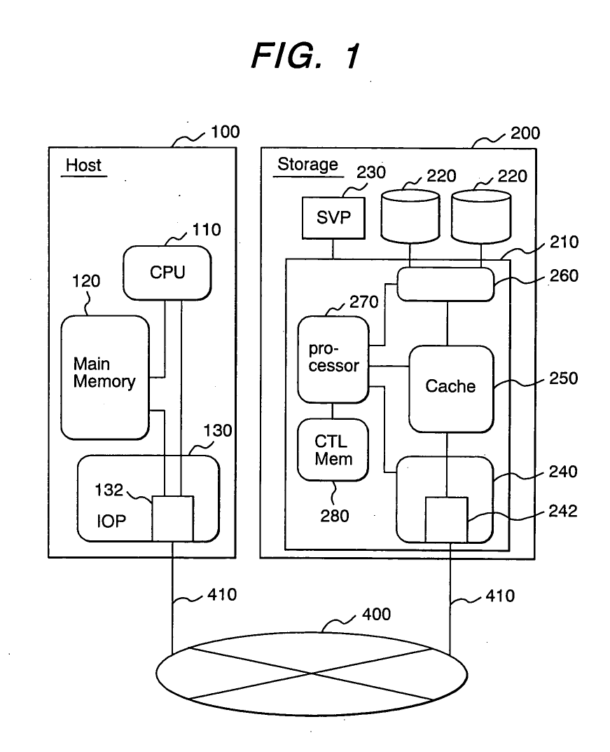

FIG. 1 is a block diagram showing the hardware configuration of a data-processing system implemented by an embodiment.

In this data-processing system, a host 100 is connected to a storage apparatus 200 by an IP network 400. The host 100 and the storage apparatus 200 exchange data in the form of packets by way of the IP network 400.

The storage apparatus 200 comprises a storage control unit 210, a plurality of disks 220 and a service processor (SVP) 230. The disks 220 form a disk array having typically a RAID configuration for storing data of a large amount. Data is written into and read out from the disks 220 in accordance with a command issued by the host 100. The SVP 230 has a display unit and an input unit. The storage control unit 210 comprises a host adaptor 240, a cache memory 250, a disk adaptor 260, a processor 270 and a control memory 280. The host adaptor 240 has an iSCSI port 242. A port 242 is connected to the IP network 400 through a high-speed IP interface 410 such as the gigabit Ethernet.

The host 100 is a computer comprising a CPU 110, a main memory 120 and an input/output-processing unit 130. To put it concretely, the host 100 is a workstation, a microcomputer, a mainframe computer or the like. The input/output-processing unit 130 has an iSCSI port 132. The port 132 is connected to the IP network 400 through a high-speed IP interface 410.

It is to be noted that the host 100 and/or the storage apparatus 200 may each be connected to the IP network 400 through a router not shown in the figure. In addition, the number of routes is not limited to one.

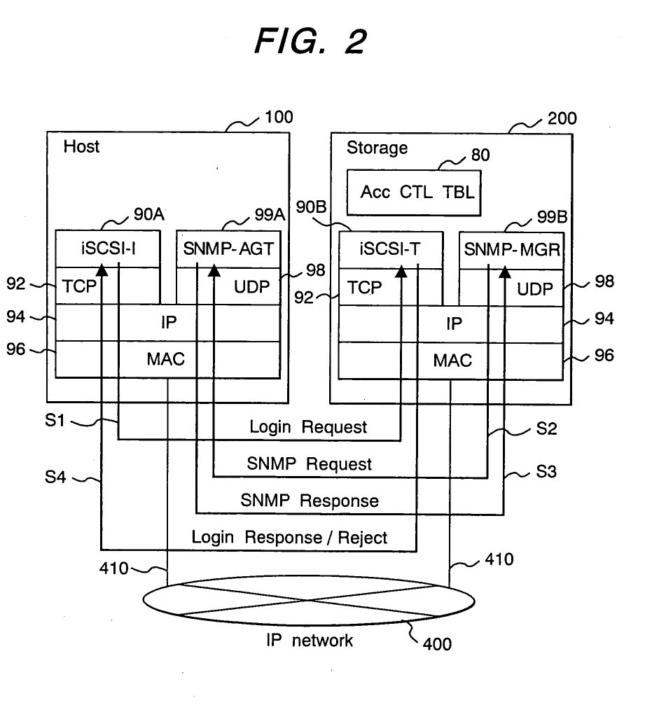

FIG. 2 is a diagram showing a logical configuration of the data-processing system shown in FIG. 1.

Data 50 and/or a command, which are originated from the host 100, are subjected to a protocol conversion process by an iSCSI initiator function on an iSCSI layer 90A. In addition, a header containing control information is added to the data 50 and/or the command in a packet process carried out at a TCP layer 92 and an IP layer 94. Finally, the data 50 or the command is transmitted to the IP network 400 from a datalink layer 96. The datalink layer 96 is also referred to as an MAC (Media Access Control) layer. Typically, the datalink layer 96 is implemented as the Ethernet (a trademark) or the gigabit Ethernet.

In the storage apparatus 200, on the other hand, the data 50 and/or the command, which are received through the IP network 400, are processed at a datalink layer 96, an IP layer 94 and a TCP layer 92 to remove various kinds of control information. Then, the data 50 or the command is supplied to an iSCSI target function of an iSCSI layer 90B in the same form output by the iSCSI initiator function of the initiator to be processed therein. The protocol processing layers, i.e., the iSCSI layer, the TCP layer, the IP layer and the datalink layer, can each be implemented by hardware, software or their combination.

It is to be noted that, when data is transmitted from the storage apparatus 200 to the host 100, protocol processes opposite to those described above are carried out.

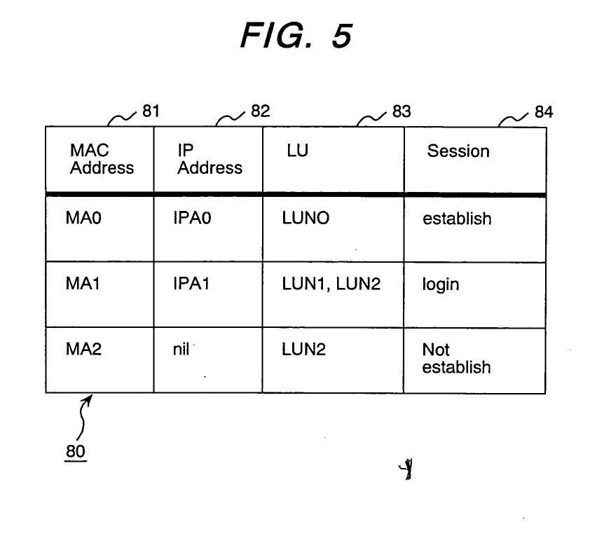

This embodiment is characterized in that an SNMP (Simple Network Management Protocol) agent 99A is implemented in the host 100 and an SNMP manager 99B is implemented in the storage apparatus 200. For this reason, the host 100 and the storage apparatus 200 each have a UDP layer 98. In addition, the storage apparatus 200 has an access management table 80 for storing information for uniquely identifying each host. It is to be noted that the contents of the access management table 80 will be explained later by referring to FIG. 5.

First of all, general effects of the SNMP (Simple Network Management Protocol) are explained briefly.

The SNMP is defined as in the IETF specifications as an RFC1157. The SNMP is a protocol for monitoring an apparatus, which is connected to a network, through the network. The SNMP is used by being prescribed on the UDP/IP. The SNMP is used for communications between an SNMP agent existing as a resident in an apparatus serving as an object of management and an SNMP manager on a monitoring server used as an apparatus on the management side. There are three kinds of communication between the SNMP agent and the SNMP manager. One of the kinds of communication is an example of communications regarding a request for information and a response to the request in this embodiment. To put it concretely, the SNMP manager transmits a request for information on an apparatus to serve as an object of monitoring to the SNMP agent. On the other hand, the SNMP agent acquires the requested information and transmits the information to the SNMP manager as a response to the request.

An apparatus managed by using the SNMP has data referred to as an MIB (Management Information Base) as data representing the state of the apparatus and has a program known as an SNMP agent as a program for manipulating the data in accordance with a command issued by an SNMP manager. It is possible to acquire both static information and dynamic information, if such static information and dynamic information are defined as MIBs. An example of the static information is the number of ports and an example of the dynamic information is a traffic state. In general, the management of an IP network most likely becomes difficult work due to a large number of apparatus composing the IP network and a variety of types of the apparatus. By utilizing the SNMP and the MIB, however, efficient management can be executed.

Much like the processes carried out at the protocol processing layers, that is, the iSCSI, TCP, IP and datalink layers, the SNMP process and the UDP protocol process can each be implemented by hardware, software or their combination. For example, as the SNMP agent 99A and the SNMP manager 99B, already prepared software can be used. If an OS of the host 100 is Linux, for example, a program released for Linux is obtained as software to be installed, and an MIB is set properly.

In this embodiment, the SNMP manager 99B is used for obtaining an MAC address. Even in the MIB structure, the SNMP manager 99B is implemented as software for partially supporting an SNMP function specialized only for obtaining an MAC address defined by MIB-2. In this case, the SNMP function can be implemented as a portion of the functions of an iSCSI target and an iSCSI initiator.

A merit of using the MAC address of the port of a host transmitting a request for an access as information for identifying the host is the fact that the number of bits composing the MAC address is small so that only a small storage area for storing the access management table is required. In addition, another merit of using the MAC address of the port is that, since the MAC address is a value peculiar to the port, the MAC address is difficult to falsify.

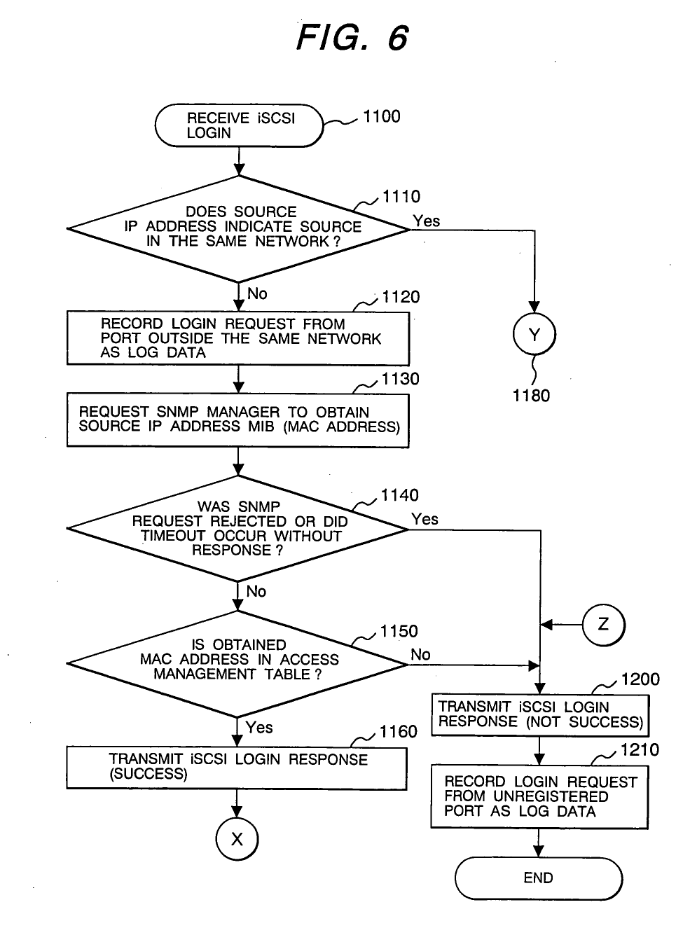

The following description briefly explains communications between the SNMP agent 99A of the host 100 and the SNMP manager 99B of the storage apparatus 200. Details of the communications will be explained later by referring to FIGS. 6 to 8.

In the storage apparatus 200 receiving an iSCSI login request S1 from the host 100, an iSCSI target function 90B issues a command to the SNMP manager 99B, requesting the SNMP manager 99B to transmit an SNMP request S2 to the network address (that is, the IP address) of the host 100 originating the iSCSI login request S1. The SNMP request S2 is a request for an MAC address.

The SNMP agent 99A of the host 100 receiving the SNMP request S2 transmits an MIB including the requested MAC address in an ordinary SNMP process as an SNMP response S3 to the SNMP request S2. Receiving the SNMP response S3, the SNMP manager 99B informs the iSCSI target function 90B of the MAC address.

The iSCSI target function 90B determines whether or not the login request is valid by finding out whether or not the acquired MAC address of the host 100 has been cataloged in the access management table 80. If the acquired MAC address of the host 100 has been cataloged in the access management table 80, the login request is approved. In order to notify the host 100 that the login request has been accepted, a response S4 is transmitted to the host 100.

After the login is established as described above, the storage apparatus 200 determines whether or not an access requested by a command received from the host 100 as an access to an LU is an LU access permitted in advance. If the access is an LU access permitted in advance, the command is processed. It is to be noted that details of a process of controlling accesses will be described later.

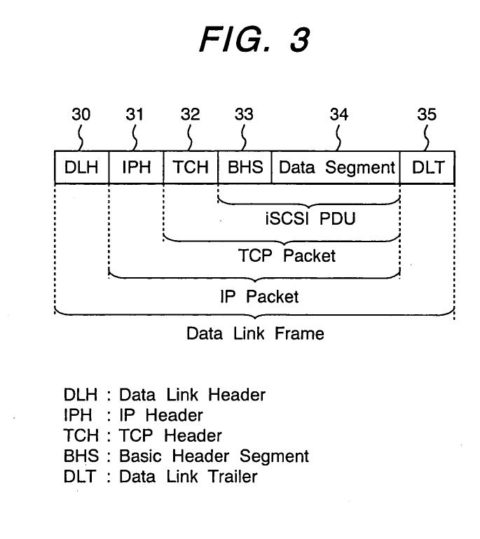

FIG. 3 is a diagram showing a typical format of a packet used in a communication between an iSCSI initiator and its target.

On an iSCSI layer, a PDU (that is, an iSCSI Protocol Data Unit) used as a data-communication unit comprises a BHS (Basic Header Segment) 33 and a data segment 34. An AHS (Additional Header Sequence) may be inserted between the BHS 33 and the data segment 34 in some cases. However, the AHS is omitted from the typical format shown in FIG. 3.

At the datalink, IP and TCP layers, respectively, a DLH (Datalink Header) 30, an IPH (IP Header) 31 and a TCH (TCP Header) 32 are added to the head of a packet of data received from the iSCSI layer. Furthermore, a DLT (Datalink Trailer) 35 is added to the end of the iSCSI packet of the data.

At the IP layer, a node is identified on the basis of a number referred to as an IP address. By the node, an apparatus connected to the network is implied. In accordance with IPv4 presently becoming very popular, a numerical value having a size of 32 bits is used as the IP address. In accordance with IPv6 of the next generation, on the other hand, a numerical value having a size of 128 bits is used as the IP address. In the IPv4 IP header, a source IP address showing a transmission origin is stored in the 13^{th} to 16^{th} bytes from the beginning of the header and a destination IP address showing a transmission destination is stored in the 17^{th} to 20^{th} bytes.

At the datalink layer, an address unique to a network card is assigned and used as a base for exchanging a datalink frame, which starts from a datalink header and ends at a datalink trailer. This unique address is referred to as the MAC address. In the case of the Ethernet, the MAC address has a size of 6 bytes. The leading 3 bytes are assigned under IEEE (Institute of Electrical and Electronic Engineers) management as a vendor code. The remaining 3 bytes are a code managed so as to avoid duplications among network cards in each vendor. An MAC address set in this way is thus assigned as an address having a unique value different from all other assigned MAC addresses, hence, having a value different from any other MAC addresses.

The first 6 bytes of the datalink header are used for storing a destination MAC address showing a transmission destination. On the other hand, the following 6 bytes of the datalink header are used for storing a source MAC address showing a transmission source.

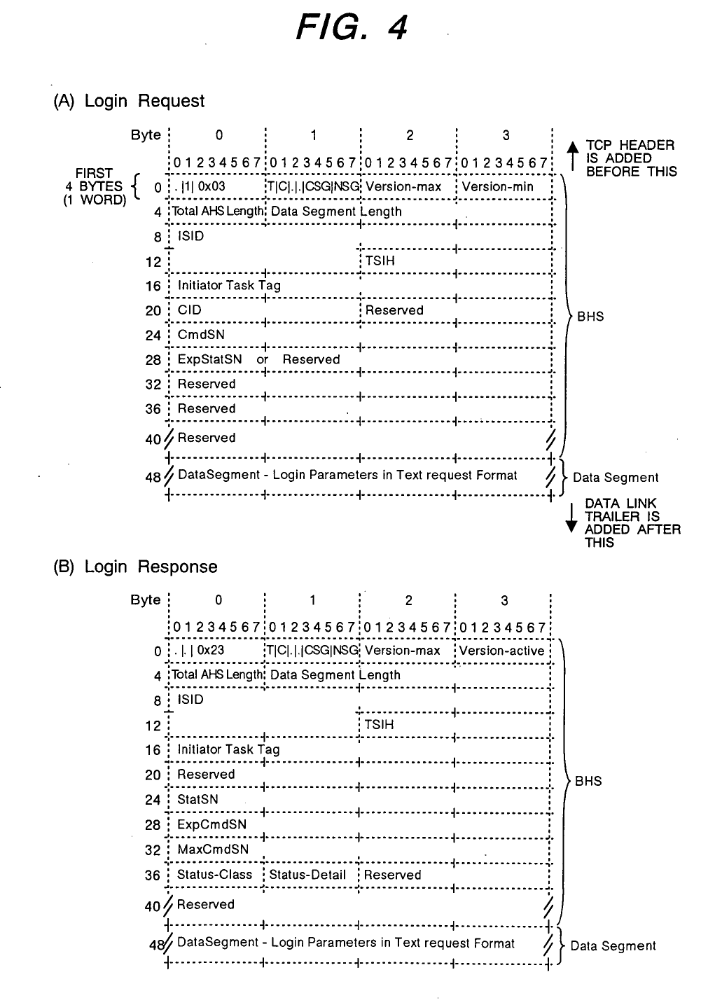

FIG. 4A is a diagram showing a typical configuration of a login request frame and FIG. 4B is a diagram showing a typical configuration of a login response.

The frames of a login request and a login response are basically similar to each other. FIG. 4A mainly shows an iSCSI PDU portion of the frame of a login request and FIG. 4B mainly shows that of the frame of a login response. In either of the frames, the BHS comprises 48 words, which each consist of 4 bytes.

A data segment is added to the end of the BHS. In the frames of a login request and a login response, a variety of parameters required for iSCSI communications are stored in the data segment. The parameters are exchanged and negotiated. Each of the parameters is described in a format referred to a TEXT format of the form ‘<key>=<value>’. The data segment has a variable length of a multiple of 4 bytes.

In a status area of a login response to a login request, the status of the login is described. The status area is an area including Status-Class and Status-Detail. Login status having a value of 0000, that is, Status-Class of 00 and Status-Detail of also 00, indicates a state in which the login has been successful, whereas login status having a value other than 0000 indicates a state in which the login has not been successful for some reasons. In this case, the initiator may make a login attempt by using other parameters or give up the login.

Next, the access management table 80 is explained by referring to FIG. 5.

On each row of the access management table 80, there are cataloged an MAC address 81 of the network interface of a host, an IP address 82 for the MAC address 81, a list 83 of LUs, to which the host having the MAC address is permitted to make an access, and a communication session 84 of a communication with the host having the MAC address.

The communication session 84 has the following values:
(1): “not established” indicating that a login request has not been received yet and therefore no communication with the host is carried out.
(2): “login” indicating that a login request has been received, being subjected to a validity determination process and, even though a login response has been given, a login has not been established yet.
(3): “establish” indicating that a login has been established.

Since the access management table 80 is a table for setting LUs to which a host is allowed to make an access, the contents of the access management table 80 are exhibited in a display unit of the console SVP 230. The contents of the table can be changed by operating the input unit.

Next, details of an access control process are explained by referring to a flowchart shown in FIGS. 6 to 8.

The flowchart begins with a step 1100 at which an iSCSI login request S1 transmitted by the host 100 is received. Then, at the next step 1110, the IP header of the iSCSI login request S1 is examined to determine whether or not the source address included in the IP header is an IP address in the same segment as the port of the storage apparatus 200.

If a result of determination indicates that the source address included in the IP header is not an IP address in the same network as the port of the storage apparatus 200, the flow of the process goes on to a step 1120 to record that a login request has been made from a port of another network as log data in the log of the control memory 280. Then, at the next step 1130, a command is given to the SNMP manager 99B to acquire an MIB for the source IP address included in the iSCSI login request frame. In accordance with this command, the SNMP manager 99B transmits an SNMP request S2 to the host 100.

Subsequently, the flow of the process goes on to the next step 1140 to determine whether or not the SNMP request S2 has been turned down by the host 100 or whether or not a timeout has occurred, that is, whether or not a predetermined time has lapsed without a response received from the host 100. If the storage apparatus 200 receives an SNMP response S3 to the SNMP request S2 without causing a timeout, the flow of the process goes on to the next step 1150 to determine whether or not an MAC address obtained from the SNMP response as the MAC address assigned to the port of the host 100 has been cataloged in the access management table 80. If a result of determination indicates that the MAC address assigned to the port of the host 100 has been cataloged in the access management table 80, the host 100 is allowed to make an access to the storage apparatus 200. In this case, the flow of the process goes on to a step 1160 at which an iSCSI response S4 is transmitted to the host 100 to indicate that the login request is approved.

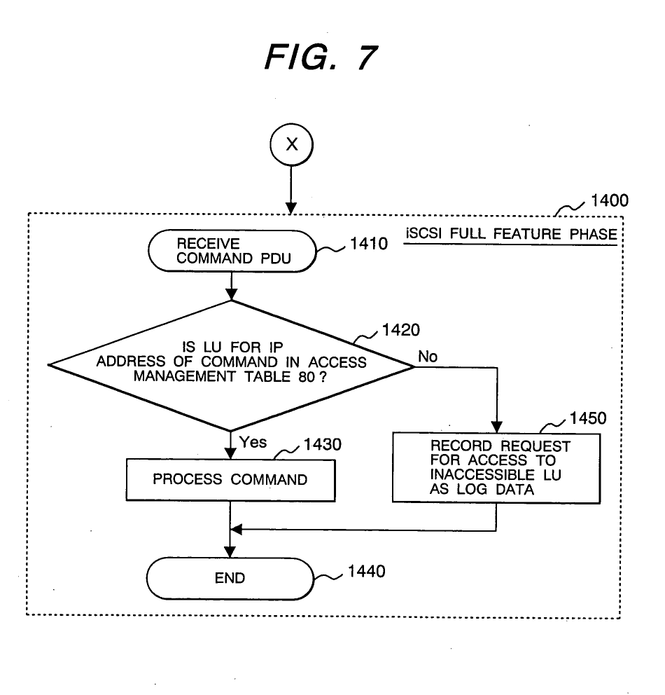

Then, the process enters an iSCSI full-feature phase 1400 shown in FIG. 7. In this case, since the host 100 making a login request exists in a segment different from that of the storage apparatus 200, a router provided on the transmission route replaces an MAC address included in each frame transmitted by the host 100 with another. Thus, as information for identifying the host 100, a source IP address of a frame transmitted by the host 100 is used.

The iSCSI full-feature phase 1400 begins with a step 1410 at which a command PDU is received from the host 100. Then, at the next step 1420, the access management table 80 is referenced to determine whether or not an LU specified by the command has been cataloged in the access management table 80 as an LU associated with the source IP address of a frame including the command. If a result of determination indicates that such an LU has been cataloged in the access management table 80, the LU is determined to be an accessible LU. In this case, the flow of the phase goes on to a step 1430 at which the command for the LU is processed. Then, at the next step 1440, execution of the processing of the command is ended.

If the determination result obtained at the step 1420 indicates that an LU specified by the command has not been cataloged in the access management table 80 as an LU associated with the source IP address, on the other hand, the requested access is determined to be a disallowed access to the LU. In this case, the flow of the phase goes on to a step 1450 to record that a request for such an access has been made as log data, and the execution of the phase is ended without carrying out the processing of the command.

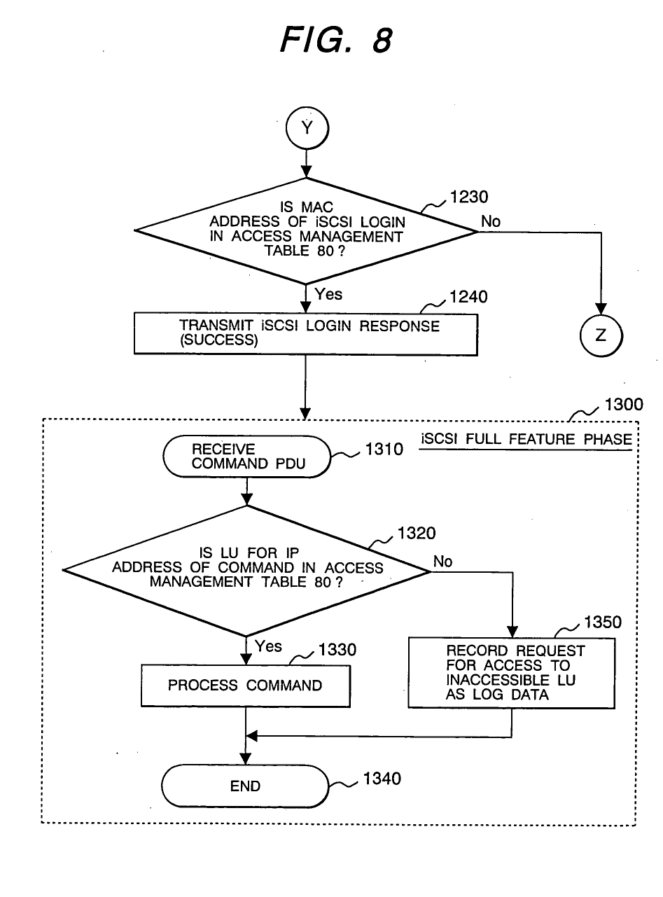

Pay attention back to the step 1110. If the determination result obtained at this step is ‘Yes’ indicating that the source address included in the IP header is an IP address in the same network as the port of the storage apparatus 200, a process shown in FIG. 8 is carried out. In this case, since the host 100 making a login request exists in the same segment as the storage apparatus 200, an MAC address included in each frame transmitted by the host 100 can be used as information for identifying the host 100.

The process shown in FIG. 8 begins with a step 1230 to determine whether or not the source address included in the iSCSI login request S1 has been cataloged in the access management table 80. If a result of determination indicates that the source address included in the iSCSI login request S1 has been cataloged in the access management table 80, accesses made by the host 100 will be permitted. In this case, the flow of the process goes to a step 1240 to transmit an iSCSI response S4 indicating that the login request has been accepted. Then, the process enters an iSCSI full-feature phase 1300. The phase 1300 begins with a step 1310 at which a command PDU is received from the host 100. Then, at the next step 1320, the access management table 80 is referenced to determine whether or not an LU specified by the command has been cataloged in the access management table 80 as an LU associated with the source MAC address of a frame including the command. If a result of determination indicates that such an LU has been cataloged in the access management table 80, the LU is determined to be an accessible LU. In this case, the flow of the phase goes on to a step 1330 at which the command for the LU is processed. Then, at the next step 1340, the execution of the processing of the command is ended.

If the determination result obtained at the step 1320 indicates that an LU specified by the command has not been cataloged in the access management table 80 as an LU associated with the source MAC address, on the other hand, the requested access is determined to be a disallowed access to the LU. In this case, the flow of the phase goes on to a step 1350 to record that a request for such an access has been made as log data, and the execution of the phase is ended without carrying out the processing of the command.

If the determination result obtained at the step 1230 is ‘No’ indicating that the source address included in the iSCSI login request S1 has not been cataloged in the access management table 80, the determination result obtained at the step 1140 is ‘Yes’ indicating that the storage apparatus 200 did not receive an SNMP response S3 to the SNMP request S2 from the host 100, causing a timeout, or the determination result obtained at the step 1150 is ‘No’ indicating that that the MAC address assigned to the port of the host 100 is not a MAC address cataloged in the access management table 80, on the other hand, the flow of the process goes on to a step 1200 to send the host 100 an iSCSI login response indicating that the login request is turned down. In this case, the status in the response is set at a value other than 0000. That is to say, since the host could not be identified by using the MAC address or the MAC address is not a MAC address cataloged in the access management table 80, the login request is determined to be a request received from an unauthorized port given no permission of an access. Then, the flow of the process goes on to a step 1210 to record that a login request has been received from an unregistered port as log data and the execution of the process is ended.

It is to be noted that, in recording the log data mentioned above, the IP address of the partner port and the generation time of the event are acquired and recorded as log records for each event. The log data itself is stored in a control memory 280. The log records acquired in this way are displayed later on the display unit of the SVP 230 in accordance with an operation carried out by a person in charge of system management or in accordance with a schedule set in advance. From the displayed log records, the person in charge of system management makes a decision as to whether or not to make a detachment from the network or determines an operation to get rid of accesses made by unauthorized hosts.

An embodiment has been described so far. A variety of modified versions of the embodiment will be described below.

In the embodiment, at the step 1110, the source IP address included in the IP packet containing the iSCSI login request S1 is examined to determine whether or not the port indicated by the source IP address as the port of the storage apparatus 200 pertains to the same segment. In a modified version, on the other hand, instead of using a source IP address, as a criterion of determination, it is possible to use a source MAC address included in the header of an Ethernet frame obtained as a result of capsulating an IP packet. That is to say, if the source MAC address included in an Ethernet frame arriving at the port of the storage apparatus 200 is the MAC address of the port of a router, the Ethernet frame can be determined to be a frame received from a source through the router. Thus, a port originally transmitting the iSCSI login request does not pertain to the same network. If the source MAC address included in an Ethernet frame arriving at the port of the storage apparatus 200 is not the MAC address of the port of a router, on the other hand, the Ethernet frame can be determined to be a frame received from a source not through the router. Thus, a port originally transmitting the iSCSI login request pertains to the same network.

In accordance with the result of determination, as a process after the determination process, the processing of the step 1120 and the subsequent steps or the processing of the step 1230 and the subsequent steps can be carried out in the same way as the embodiment.

There is another modified version of the embodiment. In the embodiment, for each command received after the establishment of a login, the host transmitting the command is identified on the basis of an MAC address or an IP address in order to determine whether or not the access requested by the command is to be approved as an access to an LU. In this other modified version of the embodiment, on the other hand, in order to meet a demand for a simpler process and a demand for a higher processing speed, the determination processes carried out at the step 1420 of the flowchart shown in FIG. 6 and the step 1320 of the flowchart shown in FIG. 7 are eliminated if the purpose is merely to turn down a login requested by a host, which is not registered at the time the login request frame is received. Thus, after the full-feature phase is started, the processing can be carried out without checking all received PDUs.

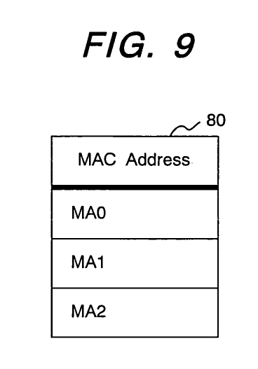

In this case, only the MAC address of each host allowed to make a request for a login is cataloged in the access management table 80. Thus, only a catalog table with a MAC-address list format like one shown in FIG. 9 is needed.

In a further modified version of the embodiment, in the full-feature address 1300 or 1400, for each command, an access requested by the command is not examined to determine whether or not the access is a permitted access to an LU by identifying a host transmitting the command on the basis of the MAC or IP address of the host. Instead, for example, only for a command requesting an operation to write data into the storage apparatus 200 is subjected to the access authentication process. That is to say, the processing can be carried out without examining any command other than such a write command in order to determine whether or not the access requested by the other command is a permitted access to an LU.

In a still further modified version, information obtained at a login time is saved in the access management table 80 even after a logout. The information includes the MAC and IP addresses of the host. The saved information can be used in the authentication process at a next login time.

There is a still other modified version of the embodiment. In the embodiment explained earlier by referring to FIG. 2, communications of data between the host and the storage apparatus are assumed. In this still other modified version, however, data is exchanged between storage apparatus. In this case, one of the storage apparatus plays the role of the host. In this still other modified version, in the storage apparatus playing the role of the host, the processor 270 employed in the storage control unit 210, protocol control hardware embedded in the host adaptor 240 or their combination carries out a protocol process, which is naturally performed by the host.

In an even further modified version, a management server is connected to one storage apparatus 200 or a plurality of storage apparatus 200 through an IP interface. The functions of the SVP 230 shown in FIG. 1 are executed in the management server. The functions include the processing to record information as log data. The management server is capable of supervising a plurality of storage apparatus in an integrated manner.

In the embodiment described above, the storage apparatus uses an SNMP request for obtaining the MAC address of the host. However, another means can also be used. For example, the storage apparatus serving as a target requests the host serving as the initiator to transmit its MAC address in accordance with a protocol referred to as an iSCSI text mode negotiation for exchanging a variety of operation parameters between the initiator and the target.

In this case, it is not necessary to provide an SNMP manager and an SNMP agent in the storage apparatus and the host respectively. However, the host must have a function for interpreting a MAC-address request included in a text request and to transmit a MAC address as a text response to the text request. The text response and the text request are each described in a text format.

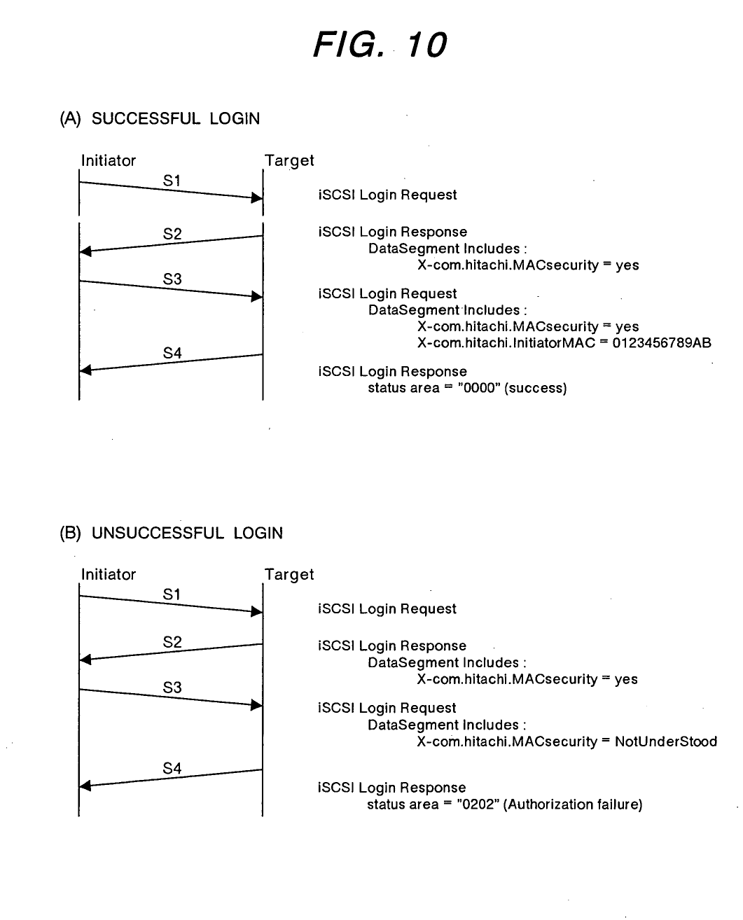

FIGS. 10A and 10B illustrate typical control processes for acquiring a MAC address in accordance with the protocol referred to as an iSCSI text mode negotiation.

When the initiator issues an iSCSI login request S1 to the target, the target transmits an iSCSI login response S2 to the initiator in response to the request S1. In this example, the iSCSI login response S2 is a data segment including a key set by the vendor as an original key starting with the character X. An example of the key is X-com . . . security. The key is used as an inquiry prepared for a case of using security based on a MAC address. Since the target shows a new parameter in this way, the initiator continues the login phase for the new parameter. In this example, the initiator knows the ‘X-com . . . security’ key and agrees with the target on the utilization of security based on a MAC address. Thus, the initiator sends the target a MAC address S3 of ‘0123456789AB’ assigned to the port of the initiator as a port used in the communication with the target. Receiving the MAC address S3 of ‘0123456789AB’, the target examines the access management table to verify that the MAC address has been cataloged in the table. Since the MAC address has been cataloged in the access management table, the login request is approved. If the MAC address has not been cataloged in the access management table, on the other hand, the target transmits a response S4 showing status with a value other than 0000 to turn down the login request.

The following description explains a case B in which a login request ends in a failure.

In accordance with the iSCSI standard, in response to an unknown key according to the protocol referred to as an iSCSI text mode negotiation, the initiator transmits a response value S3 prescribed as ‘Not understood’. Receiving the response value S3, the target sends a notice S4 indicating that the login request is not approved because the requested MAC address cannot be received.

As described above, a MAC address can be acquired by adoption of the protocol referred to as an iSCSI text mode negotiation.

Some embodiments have been explained above. However, the scope of present invention is not limited to these embodiments. It is needless to say that a variety of changes in a range not departing from essentials of the present invention can be made to the embodiments.

1. A storage apparatus for processing a command transmitted by a host computer connected to said storage apparatus by a network, said storage apparatus comprising:
a storage unit for storing data to be processed in accordance with said command;
a memory for holding an access management table for storing first information on identification of said host computer;
a first determination means for determining whether or not a frame of a login request transmitted by said host computer includes second information on identification of said host computer;
a request means for transmitting a request to a source address specified in the frame of the login request in order to request said host computer to transmit the first information on identification of said host computer in a case where the determination result output by said first determination means indicates that the frame of the login request does not include the desired second information; and
a second determination means for carrying out a determination process on the first information transmitted by said host computer in response to the request issued by said request means by examination of said access management table;
wherein a decision as to whether or not to approve the login request is made in accordance with the determination result output by said second determination means.

2. A storage apparatus according to claim 1 wherein an access is made to said storage unit by adoption of an iSCSI protocol.

3. A storage apparatus according to claim 1 wherein the first information stored in said access management table is an MAC address of an interface with an IP network through which said host computer is connected to said storage apparatus.

4. A storage apparatus according to claim 1 wherein said storage apparatus further having an SNMP manager for monitoring an apparatus connected to said IP network, and wherein said SNMP manager transmits a frame, which is used for requesting said host computer to transmit the first information, as an SNMP request for requesting said host computer to transmit an MIB of an interface related to said host computer.

5. A storage apparatus according to claim 1, further comprising a console used for changing a content of said access management table.

6. A storage apparatus according to claim 1 wherein, if the determination result produced by said second determination means indicates that the first information for identifying said host computer is not stored in said access management table, a content of said login request is stored in said memory as log data.

7. A storage apparatus according to claim 3 wherein, if the determination result produced by said second determination means indicates that the first information for identifying said host computer has been stored in said access management table, a source IP address of the login request is stored in said access management table, being associated with said information for identifying said host computer.

8. A storage apparatus according to claim 3 wherein:
said access management table is used for cataloging a MAC address and an identification code for identifying a logical unit (LU) accessible to a host computer having an IP-network interface identified by the MAC address; and
prior to processing of a command received from said host computer, an access requested by the command is examined to determine whether or not the access is an access to an accessible logical unit and the command is processed only if the access is found out to be an access to an accessible logical unit.

9. A storage apparatus according to claim 3 wherein said access management table is used for storing an IP address assigned to a host computer having an IP-network interface identified by a MAC address as an address associated with the MAC address.

10. An access control management method for managing an access permit for an access request transmitted by an external apparatus to a storage apparatus by way of a network, said access control management method comprising the steps of:
receiving a frame of a login request from said external apparatus in said storage apparatus;
determining whether or not the received frame includes second information for identifying said external apparatus in a first determination process;
requesting acquisition of first information for identifying said external apparatus from said external apparatus in a case where a result of said first determination process indicates that the frame does not include the second information;
checking said acquired first information in a second determination process in order to determine whether or not an access permit should be given to said external apparatus; and
approving an access request made by said external apparatus as a request for an access to said storage apparatus in a case where a result of said second determination process indicates that an access permit should be given to said external apparatus.

11. An access control management method according to claim 10 wherein a MAC address is used as the first information, and an IP address is used as the second information.

12. An access control management method according to claim 10, further comprising the step of preparing a table, which is used for cataloging first information for identifying an external apparatus allowed to make accesses to said storage apparatus;
wherein, in said second determination process, first information acquired from an external apparatus is checked by referencing said table in determination of whether or not an access permit should be given to said external apparatus.

13. An access control management method according to claim 10, further comprising the step of storing information on a frame of a received login request in a memory as log data in case a result of said first determination process indicates that said frame does not include said second information or a result of said second determination process indicates that an access permit should not be given to said external apparatus.

14. An access control management method according to claim 10 wherein, at said step of requesting acquisition of first information for identifying an external apparatus from said external apparatus, an SNMP manager for monitoring an apparatus connected to said IP network requests said external apparatus to transmit the first information.

15. An access control management method according to claim 10 wherein, at said step of requesting acquisition of first information for identifying an external apparatus from said external apparatus, a MAC address is obtained from said external apparatus by adoption of a protocol based on an iSCSI text mode negotiation.

16. An access control management method according to claim 15, further comprising the steps of:
defining a plurality of logical units (LUs) in said storage apparatus;
preparing an access management table for storing a MAC address and an identification code for identifying one of said logical units, which is accessible to an external apparatus having an IP-network interface identified by said MAC address; and
determining whether or not an access requested by a command transmitted by an external apparatus is an access to a specific one of said logical units, which has an identification code cataloged in advance in said access management table, with regard to processing of said command in a third determination process after said second determination process;
wherein said command is processed if a result of said third determination process indicates that said access requested by said command is an access to said specific accessible logical unit.

17. An access control management method for managing access permits for accesses made by a first apparatus as accesses to a second apparatus connected to said first apparatus by a network, said access control management method comprising the steps of:
acquiring predetermined first information from said first apparatus serving as an initiator of a communication in a case where said communication is determined to be unimplementable through said network in a first check mode of determining whether or not an access made by said first apparatus as an access to said second apparatus is an access made through said network by checking second information transmitted from said first apparatus to said second apparatus; and
processing a command transmitted by said first apparatus to said second apparatus if an access requested by said command is permitted in a second check mode of determining whether or not an access made by said first apparatus as an access to said second apparatus is permitted by checking said first information acquired from said first apparatus.

18. An access control management method according to claim 17 wherein:
said first apparatus is a host computer;
said second apparatus is a storage apparatus including a plurality of defined logical units, and processing a command by adoption of an iSCSI protocol;
said first information is a MAC address; and
said second information is an IP address included in a frame transmitted by said first apparatus to said second apparatus.

19. An access control management method according to claim 17, further comprising the step of connecting said storage apparatus comprising an iSCSI layer, a TCP layer, an IP layer and a datalink layer with an IP network.

20. A command-processing method for carrying out a communication between a first apparatus having an iSCSI initiator and a second apparatus having an iSCSI target through an IP network, said command-processing method comprising the steps of:
receiving a frame of a login request made by said first apparatus in said second apparatus;
checking whether or not said frame includes first predetermined information for identifying said first apparatus;
issuing a request from said second apparatus for acquisition of second predetermined information for identifying said first apparatus from said first apparatus in a case where said frame does not include said first predetermined information;
checking whether or not an access made by said first apparatus is to be permitted by examination of said second predetermined information transmitted by said first apparatus to said second apparatus; and
processing a command transmitted by said first apparatus to said second apparatus in said iSCSI target of said second apparatus in a case where a result of checking indicates that an access made by said first apparatus as an access to said second apparatus is permitted.

21. A command-processing method according to claim 20 wherein, as said second predetermined information, a MAC address is acquired by a communication between an SNMP agent employed in said first apparatus and an SNMP manager employed in said second apparatus.

22. A storage apparatus for executing a command received from a host computer connected to said storage apparatus by an IP network, said storage apparatus comprising:
a storage unit for storing data to be processed by execution of said command;
a memory for holding an access management table for storing first information on identification of said host computer; and
a processing unit for processing a request received from said host computer;
wherein said processing unit:
carries out a first determination process to determine whether or not a frame of a login request received from said host computer includes second information on identification of said host computer;
transmits a request to a source address specified in said frame of said login request in order to request said host computer to transmit first information on identification of said host computer, and carries out a second determination process on first information transmitted by said host computer in response to said request by examination of said access management table in a case where a determination result output by said first determination process indicates that said frame of said login request does not include desired second information; and
makes a decision as to whether or not to approve said login request in accordance with a determination result output by said second determination process.
